(19) United States
(12) Patent Application Publication
(10) Pub. No.: US 2006/0071155 A1
(43) Pub. Date: Apr. 6, 2006

(54) Safety device for garage door

(75) Inventor: Duke Chen, Hsi-Chih City (TW)

Correspondence Address: HDSL, 4331 STEVENS BATTLE LANE, FAIRFAX, VA, 22033, US

(73) Assignee: Equus Inc.

(21) Appl. No.: 11/284,967

(22) Filed: Nov. 23, 2005

Related U.S. Application Data
(63) Continuation-in-part of application No. 10/752,693, filed on Jan. 8, 2004, now abandoned.

(51) Int. Cl. G06M 7/00

(52) U.S. Cl. 250/221

(57) ABSTRACT

A safety device of a garage door includes a light guiding mirror disposed on a location adjacent to each of four corners of the garage door. A transmitter and a receiver are installed in a garage door control mechanism. Through the surrounding light guiding mirrors, the light emitted from the transmitter is reflected in a number of times by the light guiding mirrors and to be received by the receiver so that a light traveling path constructs an extensive sensing network to make the control mechanism capable of responding immediately when the garage door is closing and subject to blockage to stop closing action and return to open state. Therefore, the safety is improved when people, cars or objects are moving in and out of a garage.

### RELATED APPLICATIONS This application is a continuation-in-part of U.S. patent application Ser. No. 10/752,693, filed on Jan. 8, 2004.

### BACKGROUND OF THE INVENTION

The present invention relates to a safety device for garage door. More specifically, the present invention relates to a safety device that is built on an extensive sensing network that can assure the safety when a garage door is closing.

Presently, it is very popular to use automated garage door. It has a high practical value because it satisfies the car driver with safety and convenience when a car is moving in and out of a garage. Please refer to FIG. 1 for conventional garage door structure. On each of the two sides of a garage door 5 there is a L-shape supporting frame 50, so the garage door 5 can slide along the frame 50 through the action of the pulleys on both sides. In the center of the top, there is a fixing rod 51, which has a garage door control mechanism 52 at one end. On the fixing rod 51 there is a trolley 511 that connects to one end of a sliding rod 512, which combines with the garage door 5 at the other end. Through this structure, when the garage door 5 control mechanism 52 receives the command from a user, it automatically controls the opening and closing of a garage door 5.

To prevent the garage door 5 from hitting people when it is closing, usually there is a single-beam sensing device 53 comprising a transmitter and a receiver installed respectively nears the ground at the two sides of garage door either by cable or wireless (battery powered). Cable device uses electric wire along the garage door 5 peripheral to connect to the door control mechanism 52, while wireless device does not need wire connection, but the batteries in the transmitter and the receiver. In a practical application when the single beam is blocked, it responds to the door control mechanism 52, which immediately reverses the motion of the garage door 5 and drives the door to an open state. In this way, the safety is assured when people, cars and objects are moving in and out of the garage.

The above-mentioned garage door safety device can effectively provide safety when the door is closing. But after careful investigation, it still has the following drawbacks that need improvement:
1. Because the traditional garage door safety device uses a single-beam sensing device, practically it only detects the obstacle in one horizontal line, but not the obstacle in other horizontal lines. A false judgment can be made in some situations, such as an obstacle positioned above or below the horizontal line beam. This can end up with an accident. It cannot assure the safety of a garage door completely. It has potential risk. It also lacks flexibility and applicability.
2. Secondly, if the transmitter and the receiver adopt cable devices, the sensing devices connect to the door control mechanism through electrical wires. This causes inconvenience for installation. Besides, the wire is easy to get damaged and needs difficult maintenance. It is also easy to get signal transmission interrupted by hardly found damaged wire. This adds extra difficulty to safety control. On the other hand, the layout and exposure of the wire affects the aesthetics of garage interior. Overly arranged wiring further creates a disorganized feeling.
3. Furthermore, if the transmitter and the receiver adopt wireless devices (battery inside), battery replacement is needed when the power is out, otherwise the sensing device will not work and bring about safety concerns for people, cars and objects.

As disclosed in U.S. Pat. No. 5,063,288, several laser ray generators and sensors are arranged in parallel. Laser ray is reflected only once by any one of the several reflectors to be received by the sensor. This structure applied to the garage door safety device will make cost too high. In addition, lots of wires are needed, which will cause messy arrangement and difficult maintenance of those wires.

Knowing the drawbacks of the traditional garage door safety device, the inventor of the present invention was dedicated to the development of an extensive sensing network with improved operating range and sensitivity. Especially, it provides improved safety and progressiveness. It is a garage door safety device that possesses a significant practical value and is designed to improve the above-mentioned drawbacks. Furthermore, the present invention also provides a high level of convenience and safety.

### SUMMARY OF THE INVENTION

The present invention is to provide a garage door safety device that can significantly and extensively increase the safety of a garage door.

The safety device for garage door of the present invention comprises a garage door, a control mechanism, a movement mechanism and a light guiding mirror. The control mechanism includes a light transmitter and a light receiver, which is located above the garage door. The movement mechanism is connected to the garage door and controlled by the control mechanism to open or close the garage door. The light guiding mirror is disposed on a location adjacent to each of four corners of the garage door.

The light transmitter emits light beam to be reflected in a number of times by the light guiding mirrors and to be received by the receiver so that a light traveling path constructs an extensive sensing network to make the control mechanism capable of responding immediately when the garage door is closing and subject to blockage to stop closing action and return to open state. Therefore, the safety is improved when people, cars or objects are moving in and out of a garage.

### BRIEF DESCRIPTION OF THE DRAWINGS

FIG. 1 is a perspective view of a traditional garage door.

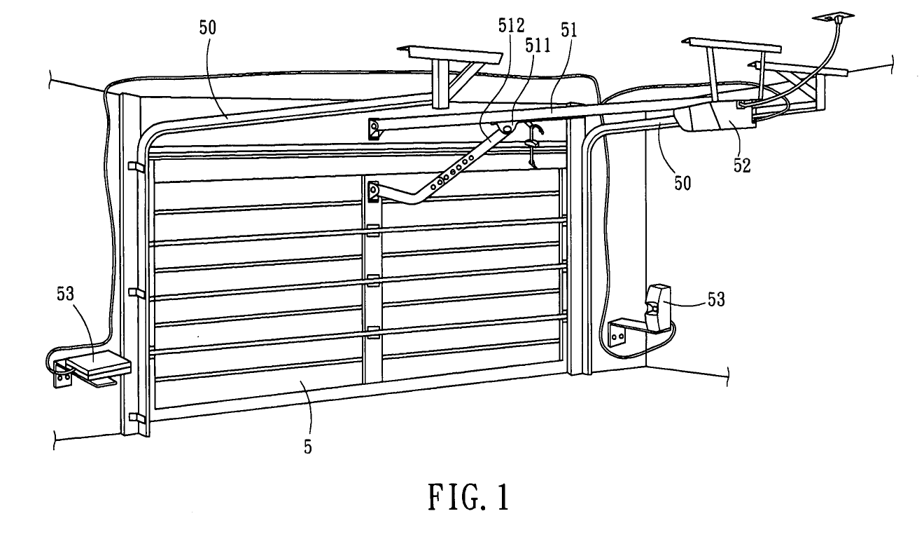

FIG. 2 is a perspective view of a safety device for garage door according to the present invention.

FIG. 3 is a front view of the garage door to illustrate a light traveling path reflected by light guiding mirrors.

FIG. 4 is a top view of the garage door to illustrate a light traveling path reflected by light guiding mirrors.

### DETAILED DESCRIPTION OF THE INVENTION

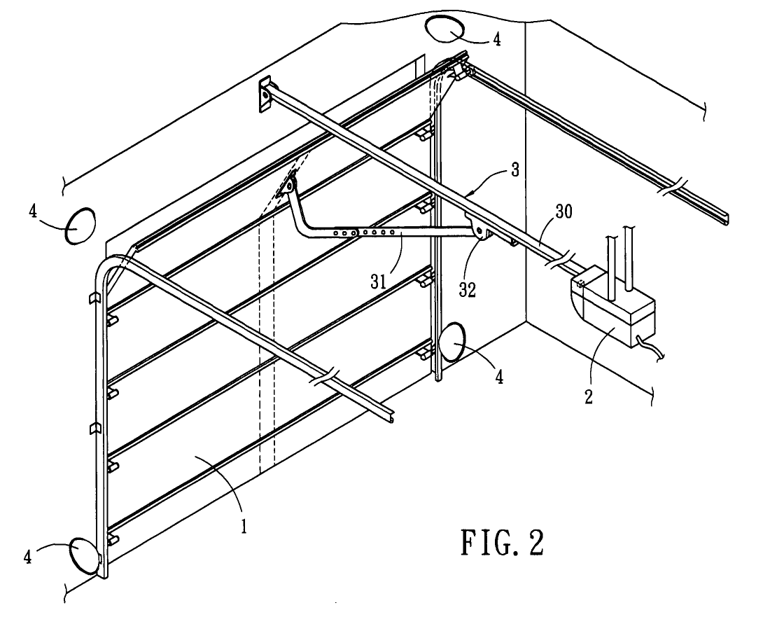

Please refer to FIG. 2, a safety device for garage door of the present invention includes a garage door 1, a control mechanism 2, a movement mechanism 3 and a plurality of light guiding mirrors 4.

The garage door 1 includes a plurality of plates connected together. A plurality of rollers are mounted on two sides of the garage door 1. Two L-shaped track is installed beside each side of the garage door 1 so that the rollers can move along the tracks to have the garage door 1 open or close.

The control mechanism 2 for controlling the garage door 1 is fixed on the garage ceiling near the rear ends of the tracks. The control mechanism 2 includes a motor and a driving device connected to the motor. A light transmitter 20 and a light receiver 21 are installed inside the control mechanism 2.

The light guiding mirror 4 is disposed on a location adjacent to each of four corners of the garage door 1. Preferably, the light guiding mirror 4 is a paraboloidal mirror.

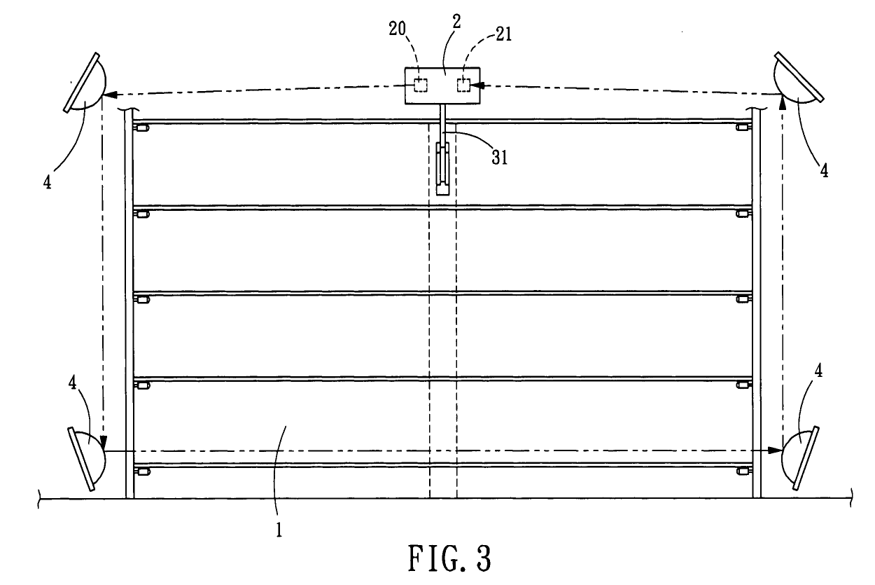

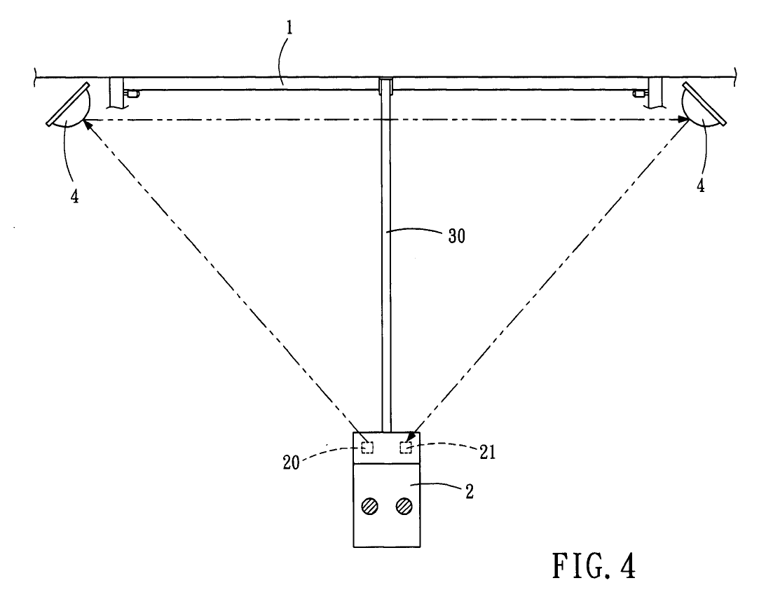

Please refer to FIG. 3 and FIG. 4, the light transmitter 20 emits light beam, such as laser ray or infrared ray, to be reflected in a number of times by the light guiding mirrors 4 and to be received by the receiver 21 so that a light traveling path constructs an extensive sensing network to make the control mechanism capable of responding immediately when the garage door is closing and subject to blockage to stop closing action and return to open state. Therefore, the safety is improved when people, cars or objects are moving in and out of a garage.

From the above description, the present invention adds a transmitter and a receiver in the garage door control mechanism. With a number of light guiding mirrors, the invention constructs a complete and extensive sensing network. Its installation is so simple that it does not need the traditional method that puts a transmitter and a receiver under the door and needs exposed wires for connection to the door control mechanism. Especially due to the absence of exposed wires, it offers an aesthetic feeling visually. It also eliminates the unorganized feeling because there is no overly arranged wiring. In addition, the invention provides a means to prevent signal loss due to hardly found wire damage. The maintenance becomes much easier. It is unlikely for the sensing device not to operate due to negligence about replacing batteries when power is out as in the traditional wireless device. This prevents risks to the safety of people, cars and objects moving in and out of the garage.

To summarize the above description, the garage door safety device in the present invention provides a high level of safety and applicability. The extensive sensing network is considered as technical breakthrough in the field. Due to its practical value in industrial application, the invention should meet the patent requirements. A patent application is thus filed.

1. A safety device for garage door comprising:
a garage door,
a control mechanism including a light transmitter and a light receiver, located above the garage door;
a movement mechanism connected to the garage door, controlled by the control mechanism to open or close the garage door, and
a light guiding mirror disposed on a location adjacent to each of four corners of the garage door,
wherein the light transmitter emits light beam to be reflected in a number of times by the light guiding mirrors and to be received by the receiver so that a light traveling path constructs an extensive sensing network to make the control mechanism capable of responding immediately when the garage door is closing and subject to blockage to stop closing action and return to open state.

2. The device of claim 1, wherein the light beam is one of laser ray or infrared ray.

3. The device of claim 1, wherein the light guiding mirror is a paraboloidal mirror.
